(19) United States
(12) Patent Application Publication
(10) Pub. No.: US 2010/0201169 A1
(43) Pub. Date: Aug. 12, 2010

(54) Dental Chair Toe Cover

(76) Inventors: Graig S. Fox, Gilibert, AZ (US); Neal L. Fox, Gilbert, AZ (US)

Correspondence Address: LOEN PATENT SERVICES, 2266 S Dobson Road, Mesa, AZ, 85202, US

(21) Appl. No.: 12/701,476

(22) Filed: Feb. 5, 2010

Related U.S. Application Data
(60) Provisional application No. 61/150,750, filed on Feb. 7, 2009.

(51) Int. Cl. A61G 15/10

(52) U.S. Cl. 297/223

(57) ABSTRACT

The present invention is an improved toe cover that is designed to be useful for a variety of dental chairs. It is a two piece system joined together comprising a flexible plastic designed in a specific shape with an additional flexible panel. The two pieces are permanently joined together and an optional method incorporates printed material on the exposed cover so that the patient will see a work of art or similar item of interest.

### CROSS REFERENCE TO RELATED APPLICATIONS

This application claims the benefit of U.S. Provisional Application No. 61/150,750 filed on Feb. 7, 2009. The provisional application is incorporated by reference herein.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

This invention is directed toward to sanitary protective flexible slip on covers for dental chairs. In particular, the present invention is a universal slip on cover that is suitable to a variety of dental chair models utilizing flexible and rugged materials that will withstand the daily use in a dental office environment.

(2) Description of Related Art

Currently, the most common practice is to utilize specific covers designed for a particular dental chair. The cover is made out of a flexible clear plastic and attached by snaps or by a hook and loop attachment. The method of attachment is often awkward and requires the dental hygienist to bend over and struggle with securing the cover. The area underneath a dental chair is less important for sanitation and it is undesirable for a hygienist to struggle with a toe cover while otherwise operating in a sterile environment.

U.S. Pat. No. 1,737,505 describes a dental chair and mentions a foot board in the form of a cast plate with a suitable cover comprising a rubber mat secured by angle plates. There is no mention of a slip on cover that is designed for a universal fit for a variety of chairs.

U.S. Pat. No. 2,785,737 describes a dental chair foot rest and includes a brief description of a conceptual idea of a sanitary protective cover as a disposable chip-tray. Again, there is no mention of a slip on cover that is designed for a universal fit for a variety of chairs.

In actual field practice, current toe cover methods are lacking in important practical aspects. The need for a tight fit often requires the cover to be stretched over the snaps.

Others have worked on sanitary head rest covers, but these tend to be disposable and used only once due to the need to prevent head lice and other transmissible diseases. Foot covers on dental chairs are used for multiple patients and do not have the same sanitary requirement. In actual use, they eventually wear out and need to be replaced on a moderately frequent basis, and a rapid universal fit is highly desirable.

### BRIEF SUMMARY OF THE INVENTION

The present invention is a significant improvement of toe covers, wherein a toe cover is a multi-piece design so that the end of the dental chair is enclosed by the slip on cover. The design utilizes a rugged clear plastic which is connected to a flexible—stretching material that provides the necessary adaptation for a universal fit. The design incorporates two main pieces suitably sewn together for a universal fit, and an optional method to incorporate printed material on the exposed cover so that the patient will see a decoration, logo, or a work of art.

### BRIEF DESCRIPTION OF THE SEVERAL VIEWS OF THE DRAWING(S)

FIGS. 1A and 1B show the top cover piece of the present invention.

FIGS. 2A and 2B shows the bottom piece of the present invention.

FIG. 3 shows the present invention installed on a dental chair.

FIG. 4 shows the present invention installed on a dental chair with included laminated artwork installed under the toe cover.

FIG. 5 shows an assembly of the present invention.

### DETAILED DESCRIPTION OF THE INVENTION

The present invention primarily comprises two parts that are sewn or bonded permanently together for the purpose of creating a slip on cover for a foot rest portion of a dental chair. This cover is also called a Toe Cover. The first piece is a clear or solid flexible plastic that is the primary piece which is in contact with both the patient and the chair. It is the most visible piece and also the piece that sees the most wear and tear. It is the piece that is on the upper side of the dental chair. It is cut out into a specifically defined shape to allow both a slip on cover and also a shape that will allow a snug fit for a wide variety of dental chairs. The shape design has a broad range which will fit various design chairs.

The second piece is an elastic panel that is in the general shape of a rectangle. The size is chosen to match the first piece and provide the snug, universal fit for the broad variety of chairs, already mentioned. The combination of first and second pieces of the present invention provides the ability needed to adapt to a wide variety of dental chairs.

The present invention provides for a one size toe cover that will fit a broad variety of dental chairs. Presently, in the dental market, the only toe covers available are specific to a particular dental chair model which requires the cover to attach and fit according to a predetermined design. The attachment is by snaps, Velcro©, or even stapled directly to the chair. In many instances, a dental technician is needed to install it which requires an expensive service charge. The model specific toe covers often require stretching and pulling to get the Velcro, snaps, or staples to secure the cover. A slip on toe cover, according to the teachings of the present invention, is made with a stretchable panel sewn in, which provides for a snug fit and a simplified installation. This eliminates the need for a toe cover to be model specific.

The present invention may be ordered and installed without any specialized equipment or special training. A dentist or an assistant can easily slip it right over the end of the chair. The elastic panel provides for a simple and immediately recognizable method of pulling it right onto the dental chair, and after it is put in place, the properties of the elastic panel hold it in place.

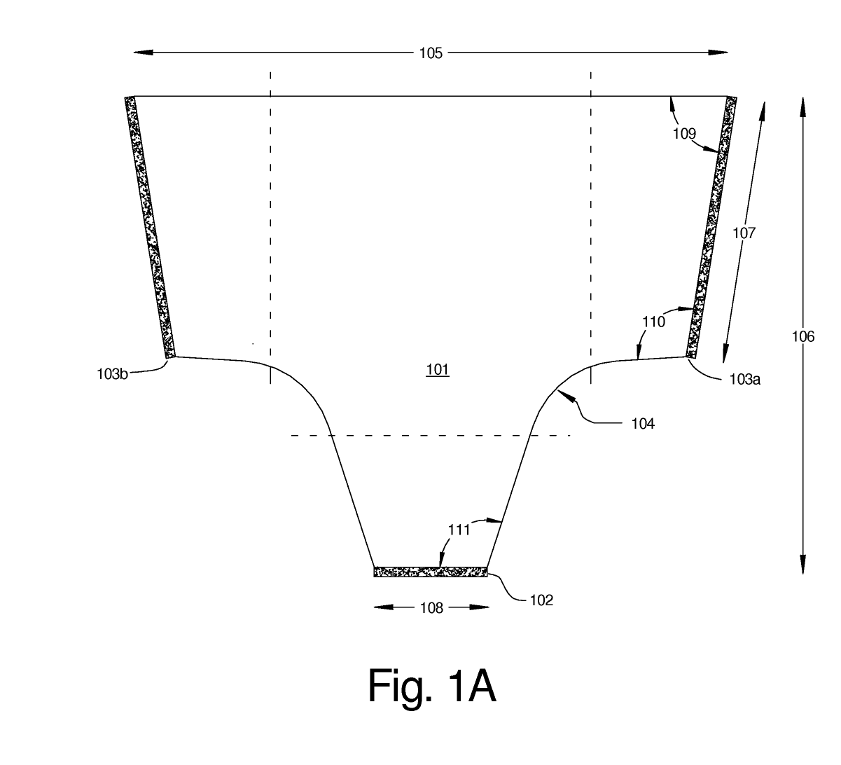

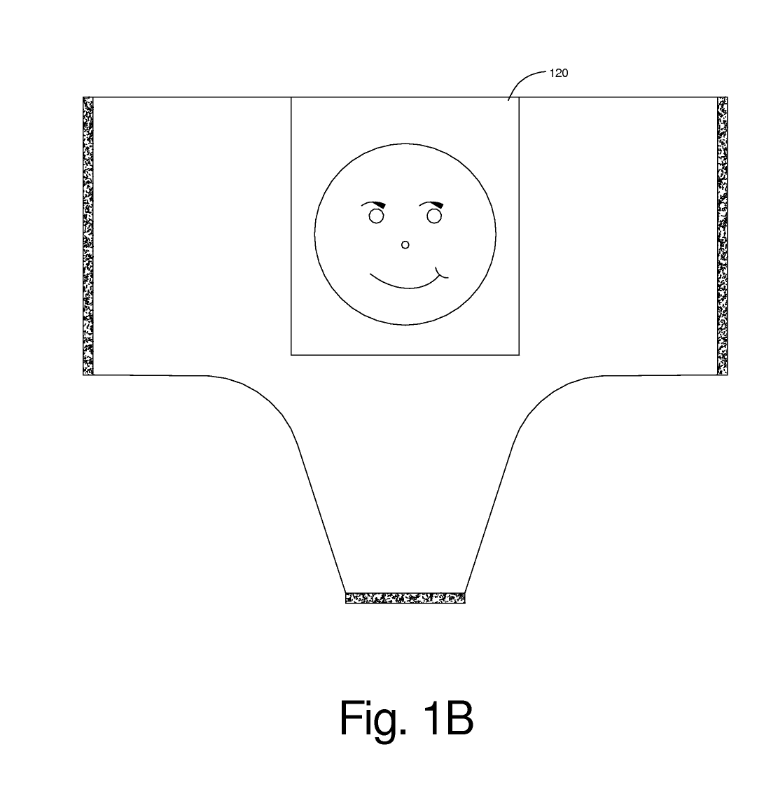

In reference to FIG. 1A, a top cover piece 101 is made of a flat clear flexible plastic from 1 to 10 mils thick. It will be attached to a second piece at a bottom edge 102 and two side edges 103a,b. Approximate bending lines are illustrated by dashed lines, as the combined assembly will be three dimensional. The illustration is a general shape design, and the actual dimensions may be adapted as required to form a necessary snug fit. The overall shape is a combination between two pieces: a top cover piece and a bottom piece.

In one embodiment of the present invention, the top cover piece has length dimensions 105, 106, 107, 108, and radius 104 of 31.5, 25, 14, 6, and 5 inches respectively. Angular dimensions 109, 110, and 111 are 81, 103, and 108 degrees respectively. These dimensions are approximate, and vary a few inches and several degrees respectively, depending upon the second piece dimensions and the desired tightness of the fit.

In one embodiment, the dimensions just above listed are important, and provide optimum fit for a variety of dental chairs.

In practice, height 106 may vary significantly if the toe cover is desired to be shortened due to interference with other equipment mounted on the dental chair.

In another embodiment of the present invention, artwork is added to the top cover piece to provide a friendly environment for the patient. The artwork is preferably added under the top cover piece by laminating or sewing a flat backing piece behind the artwork. FIG. 1B illustrates artwork 120 that has been added to the underside of the top cover piece.

The general geometric design of the top cover piece as illustrated in FIGS. 1A, 1B would be a six sided shape with a top edge, a left edge, a left curved edge, a bottom edge, a right curved edge, and a right edge in sequence around the perimeter. The top and bottom edges are parallel to each other and centered relative to each other. The top edge is longer than the bottom edge. The left and right edges project outwardly from the top edge, and are perpendicular to the top edge or are tapered inward toward the center of six sided shape. The left and right edges are substantially equal in length and symmetrical about the center of the six sided shape. The left curved edge incorporates a radius of curvature which is substantially the same radius of curvature incorporated into the right curved edge. The left curved edge also incorporates two line segments which are perpendicular to the left edge and bottom edge respectively, or just beyond perpendicular as illustrated.

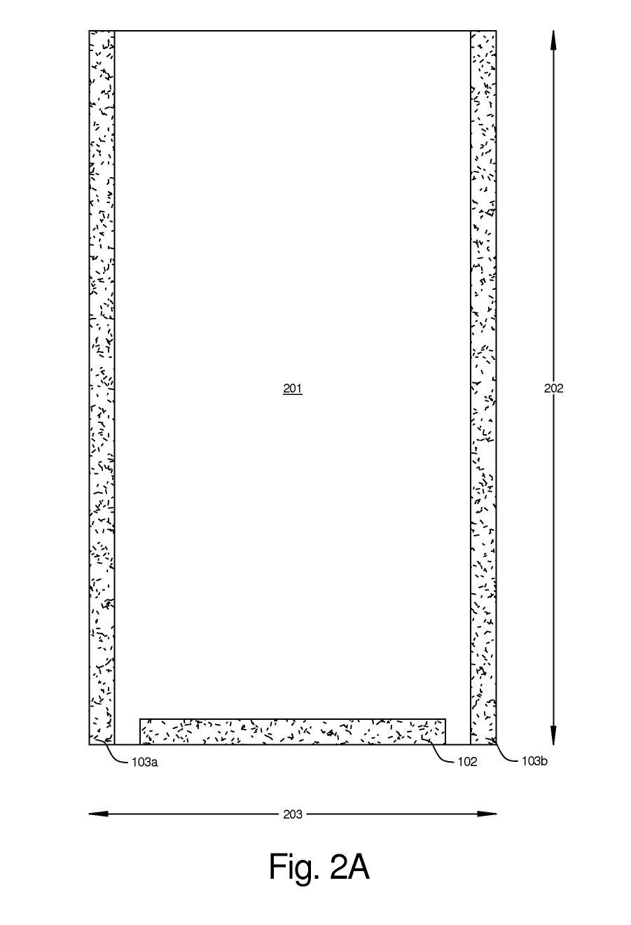

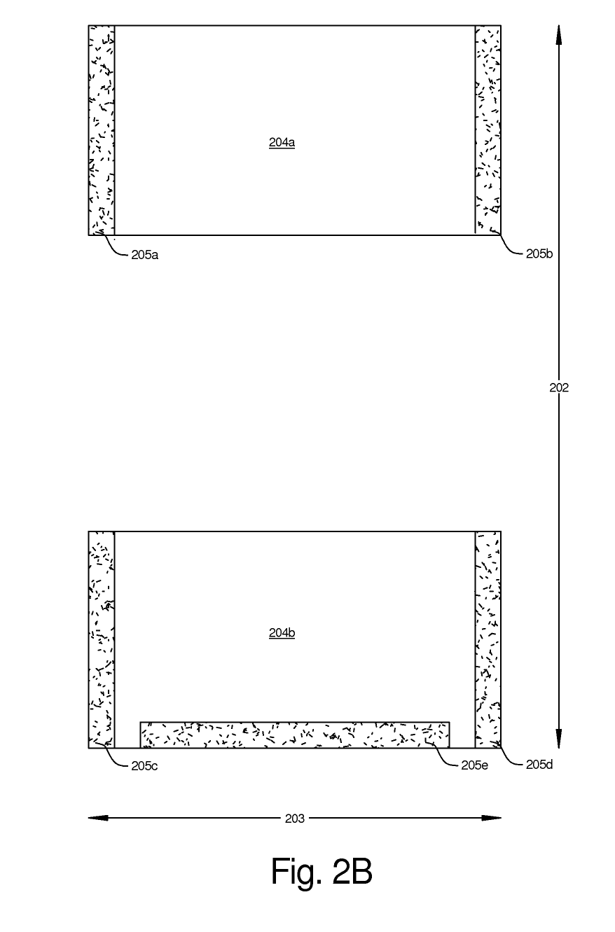

In reference to FIG. 2A, a bottom piece 201 is made of a flat flexible material with overall dimensions 202, 203 of 14 and 8 inches respectively. It is attached to the top cover piece at the bottom edge 102 and two side edges 103a,b. As shown, the illustration is a substantially rectangular shape, and actual dimensions may be adapted as needed for a snug fit. In one embodiment, the flexible panel may be taken from a larger flexible panel and folded in half. The flexible material may be made of such rugged materials as used in sports wear, such as spandex.

FIG. 2B shows the bottom part of the Toe Cover as two similarly sized rectangular pieces. For many dental chairs, a two piece 204a, b assembly provides for the bottom part of the Toe Cover is an advantage for better flexibility, especially when the Toe Cover is installed over an end that is tapered. Also, use of an elastic material is preferred. The edges 205 a, b, c, d, e are used to sew the two pieces 204a, b to the edges 102 and 103 a, b of top part of the Toe Cover.

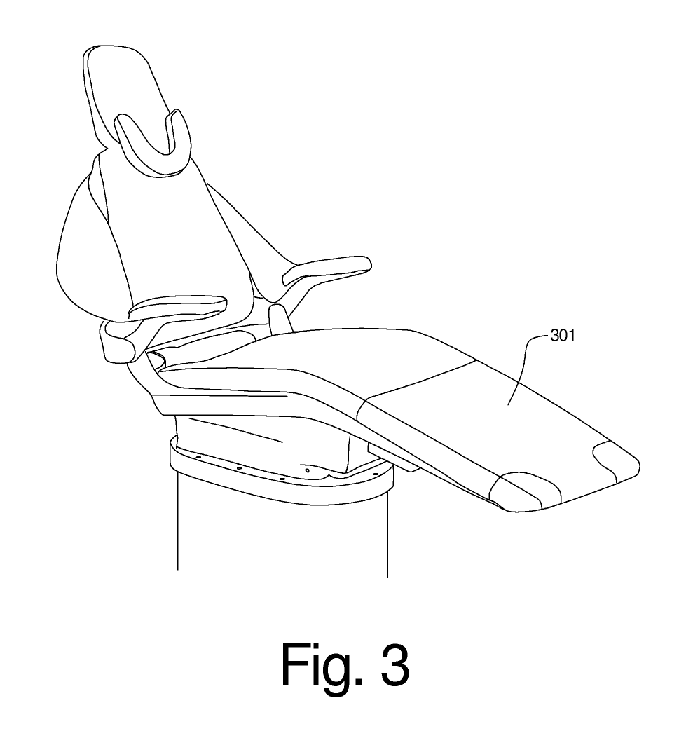

In reference to FIG. 3, the Toe Cover 301 is shown installed on a typical dental chair by sliding over the end. The top clear piece is visible to the patient, and the flexible bottom piece of the Toe Cover is underneath the chair out of sight.

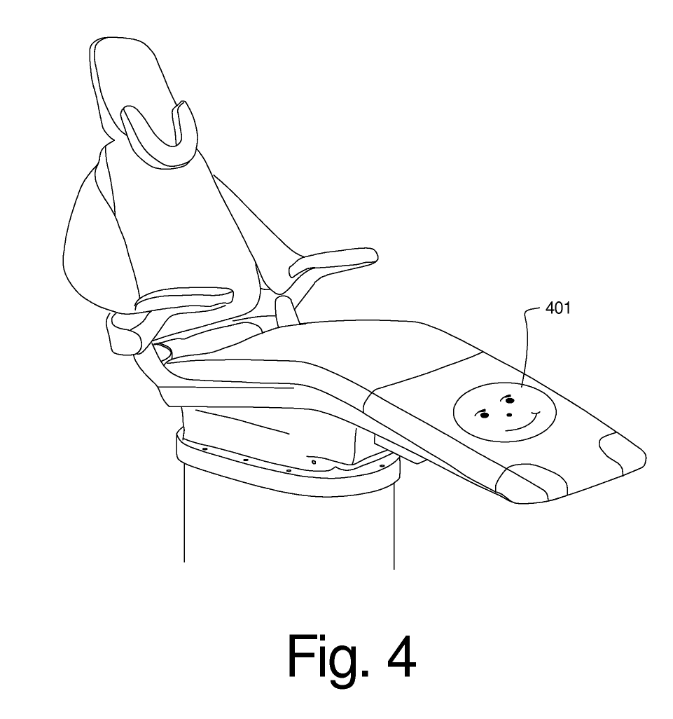

In reference to FIG. 4, the Toe Cover is installed with artwork 401 laminated or sewn on the underside of the top cover piece. The artwork may be anything suitable or desirable for a dental office, such as logos, advertising, scenery, cartoons, etc.

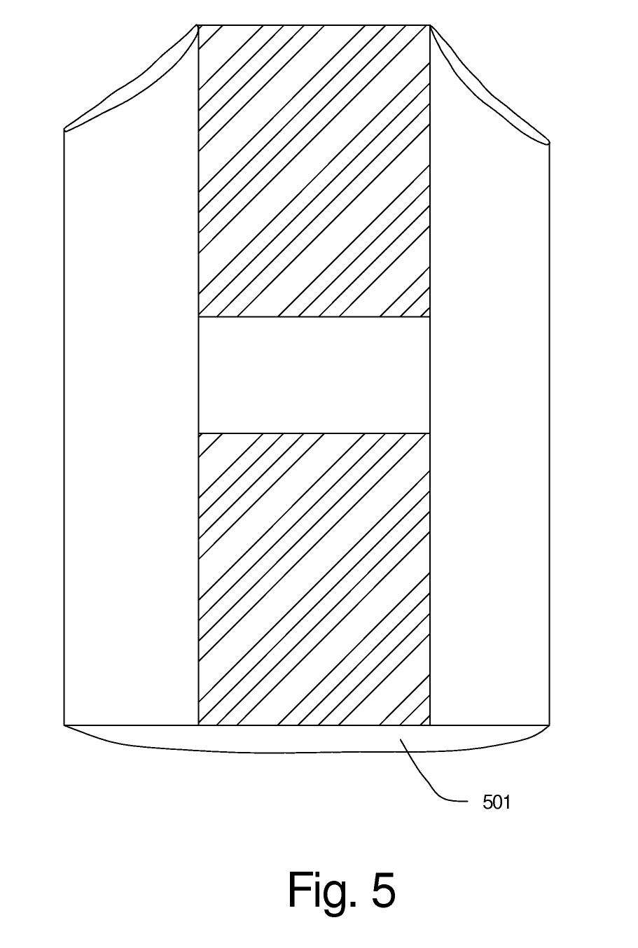

FIG. 5 shows an assembly of the present invention. The assembly is sewn together and the bottom piece shown is described in FIG. 2B. An opening 501 allows for insertion onto a dental chair.

As another embodiment of the present invention, padding or a memory foam cushion may be added over the toe cover by sewing it in on the top.

While various embodiments of the present invention have been described, the invention may be modified and adapted to various operational methods to those skilled in the art. Therefore, this invention is not limited to the description and figures shown herein, and includes all such embodiments, changes, and modifications that are encompassed by the scope of the claims.

I claim:

1. A toe cover for a dental chair comprising:
a) a top cover piece comprising a flexible material,
b) wherein said flexible material has a substantial uniform thickness between 0.001 to 0.010″ inclusive,
c) wherein said top cover piece is cut into a six sided shape,
d) wherein said six sided shape has a top edge and a bottom edge that are substantially parallel, are centered relative to each other, and are a first dimension apart,
e) wherein said top edge is a second dimension in length, and said bottom edge is a third dimension in length, wherein said second dimension is greater than said third dimension,
f) wherein said six sided shape has a right edge and a left edge which lie between said top edge and said bottom edge, are symmetric relative to a centerline connecting said top edge and said bottom edge, and are each at an angle relative to said top edge by a first angular dimension as measured by a rotation from said top edge to a respective edge,
g) wherein said right edge and said left edge are substantially equal in length and are a fourth dimension in length,
h) wherein said right edge is joined to said lower edge by a right curved edge, wherein said right curved edge incorporates a radius of curvature, wherein said radius of curvature is a fifth dimension in length,
i) wherein said left edge is joined to said lower edge by a left curved edge, wherein said left curved edge incorporates an equal said radius of curvature,
j) a bottom piece, wherein said bottom piece is made from elastic material,
k) wherein said bottom piece is substantially rectangular,
l) wherein said bottom piece is substantially
i. a single rectangular piece with length and width dimensions of a sixth and seventh dimension respectively, or
ii. multiple pieces resulting in an assembly that fits within a rectangular shape with length and width dimensions of a sixth and seventh dimension respectively,
and
m) wherein said top cover piece and said bottom piece are joined together on three edges of said top cover piece,
whereby a toe cover useful for slipping onto one end of a dental chair is created.

2. The toe cover for a dental chair according to claim 1 wherein
said first dimension is substantially 25 inches in length,
said second dimension is substantially 31.5 inches in length,
said third dimension is substantially 6 inches in length,
said fourth dimension is substantially 14 inches in length,
said fifth dimension is substantially 5 inches in length,
said sixth dimension is substantially 14 inches in length,
said seventh dimension is substantially 8 inches in length, and
said first angular dimension is substantially 81 degrees.

3. The toe cover for said dental chair according to claim 1 wherein said toe cover is slipped onto said dental chair over the foot end of said dental chair.

4. The toe cover for said dental chair according to claim 1 wherein artwork is added to said top cover piece by lamination or by adding an additional flat panel to said top cover piece.

5. The toe cover for said dental chair according to claim 1 wherein padding or a memory foam cushion is added over said toe cover by sewing it in on the top.

6. A toe cover for a dental chair comprising:
a) a top cover piece comprising a flexible material,
b) wherein said flexible material has a substantially uniform thickness,
c) wherein said top cover piece is cut into a six sided shape with six contiguous edges,
d) wherein said six contiguous edges comprise a top edge, a left edge, a left curved edge, a bottom edge, a right curved edge, and a right edge,
e) wherein said top edge and said bottom edge are substantially parallel and are centered relative to each other,
f) wherein said top edge is longer than said bottom edge,
g) wherein said right edge and said left edge are attached to said top edge and wherein said right edge and said left edge projects outwardly from said top edge,
h) wherein said right edge and said left edge are substantially equal in length,
i) wherein said left curved edge connects said left edge to said bottom edge, and said right curved edge connects said right edge to said bottom edge,
j) wherein said left curved edge and said right curved edge each incorporates a radius of curvature,
k) a bottom piece, wherein said bottom piece is made from elastic material,
l) wherein said bottom piece is substantially
iii. a single rectangular piece, or
iv. multiple pieces resulting in an assembly that fits within a rectangular shape, and
m) wherein said top cover piece and said bottom piece are joined together on three edges of said top cover piece to create a toe cover assembly with an opening for inserting onto an end of said dental chair.
